(19) United States
(12) Patent Application Publication
(10) Pub. No.: US 2004/0073497 A1
(43) Pub. Date: Apr. 15, 2004

(54) Method and system for automated linkable promotions

(76) Inventors: Mark R. Hayes, Wilmington, DE (US); George W. Blossom, West Chester, PA (US); Michael S. Kutsch, Wilmington, DE (US); Christopher Novak, Newark, DE (US); Robert Riesenbach, Cherry Hill, NJ (US); Maryann M. Sharkey, Wilmington, DE (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/270,287

(22) Filed: Oct. 15, 2002

(51) Int. Cl. G06F 17/60

(52) U.S. Cl. 705/27

(57) ABSTRACT

The invention comprises an electronic purchasing system. In one embodiment, the electronic purchasing system may operate through a user communicating with a system server and at least one partner system over a network. The user possesses an electronic wallet and an electronic coupon book that facilitate purchasing. The electronic coupon book is stored on a smart card and receives its coupons either from the system server or from the partner system for either immediate or subsequent use by the user system. In another embodiment, the user may be provided with a system having coupon downloading tools, vendor recognition tools, purchasing tools, an input device for receiving account access information and communication tools for communicating with vendors, and the user can use a conventional credit card to consummate purchases using downloaded coupons. In either embodiment, the user system and the partner system are capable of recognition in order to activate coupons only for appropriate participants.

### FIELD OF THE INVENTION

The invention of the present application relates to a method and system for automatically providing electronic purchasers with incentives such as promotions and discounts based on purchaser behavior.

### BACKGROUND OF THE INVENTION

Electronic purchasing, particularly through web sites over the Internet, has become a wide spread practice. Various systems and methods have been proposed for facilitating electronic purchasing.

When vendors offer items for purchase over a web site, they typically strive to make discounts and sales available in the same manner in which a typical retail establishment offers discounts and promotions. For example, in some instances, online vendors will require a user to enter a coupon code in order to receive a discount. The coupons may be mailed or sent via email to potential purchasers.

In a more traditional purchasing environment in which a user purchases goods or services in person, payment may be performed electronically with smart cards, credit cards, or debit cards. A magnetic strip on any of these cards may store information that qualifies the card user for a discount when the card is presented at selected establishments. In this instance, although the user ultimately receives a discount or a credit for the discounted amount, the user may receive a receipt for the full price amount and may not know that a discount has been generated until a substantial amount of time has passed.

However, the prior art systems fail to provide an automated system for providing discounts to a user, wherein the user is informed of the discount prior to or during the course of an actual purchase transaction.

### SUMMARY OF THE INVENTION

Accordingly, an electronic purchasing system is provided for generating automatic linkable promotions, thereby enabling a user to purchase goods and services from at least one vendor. In one aspect of the invention, the purchasing system includes an electronic wallet. The electronic wallet stores access information for at least one user account and electronic purchasing tools for allowing a user to complete a purchase transaction using the access information. The electronic purchasing tools further comprise a smart card for communicating with the at least one vendor. The smart card comprises an electronic coupon book for storing at least one electronic coupon for use at the at least one vendor, vendor recognition tools for automatically accessing an applicable electronic coupon upon recognizing a participating vendor, and coupon downloading tools for transferring an applicable electronic coupon to the electronic coupon book. The purchasing tools use the account access information and the applicable electronic coupon for purchasing the goods or services (or any other sellable item) from the participating vendor.

In another aspect of the invention, the user system enables a user to purchase goods and services from at least one vendor. The user system has coupon downloading tools for transferring coupons, and each of the coupons includes promotion terms. The user system further includes vendor recognition tools for identifying a specific vendor and identifying at least one applicable electronic coupon associated with the specific vendor, purchasing tools, an input device for receiving account access information from a user and communication tools for communicating with at least one vendor system. The purchasing tools are adapted to allow a user to complete a purchase transaction using the account access information, and at least some of the terms of the purchase transaction are modified by reference to the promotion terms of the applicable electronic coupon associated with the specific vendor.

In still another aspect of the present invention, a method is provided for allowing a user to utilize automated coupons from multiple vendors. The method includes the steps of providing a user with an electronic wallet and a smart card, wherein the smart card stores at least one automated coupon; detecting behavior of the user; implementing notification tools on the smart card to provide the user with notification of an applicable automated coupon in response to the user's behavior; and enabling the user to purchase goods or services over the network using the electronic wallet and at least one automated coupon.

In another aspect of the present invention, a method is provided for allowing a user to utilize automated coupons from at least one participating vendor over a network. The method includes the steps of providing a user with at least one automated coupon, determining whether a user is accessing a participating vendor, implementing notification tools to provide the user with notification of an applicable automated coupon in response to the user accessing a participating vendor, receiving payment information from a user and enabling the user to purchase goods or services using the payment information and the at least one automated coupon, wherein at least some of the terms of the purchase are modified by the automated coupon.

Additional objects and advantages of the invention will be set forth in the description which follows, or will be obvious from the description, or may be learned by practice of the invention.

### BRIEF DESCRIPTION OF THE DRAWINGS

The accompanying drawings, which are incorporated in and constitute a part of this specification, together with the description, serve to explain the principles of the invention.

FIG. 1 is a block diagram illustrating an embodiment of the system of the invention.

FIG. 2A is a block diagram illustrating a smart card in accordance with an embodiment of the invention.

FIG. 2B is a block diagram illustrating an embodiment of a system for receiving a smart card.

FIG. 3 is a block diagram illustrating an embodiment of a system server of the invention.

FIG. 4 is a block diagram illustrating an embodiment of a participating partner system of the invention.

FIG. 5 is a block diagram illustrating another embodiment of a user system in accordance with an embodiment of the present invention.

FIG. 6 is a flow chart illustrating the procedures involved in making an electronic purchase in accordance with an embodiment of the invention.

FIG. 7 is a flowchart illustrating steps of one of the procedures of FIG. 6.

FIG. 8 is a flow chart illustrating steps of another of the procedures of FIG. 6.

FIG. 9 is a flow chart illustrating steps of another of the procedures of FIG. 6.

FIGS. 10A and 10B are flow charts illustrating alternative embodiments for loading coupons onto a smart card or a database associated with a smart card.

### DETAILED DESCRIPTION OF THE PREFERRED EMBODIMENTS

The present invention provides a system and method for providing discounts, coupons, special offers or other incentives to a system user. The user may shop and make purchases using a smart card issued by the system (the system acts as the smart card “issuer”). The smart card may be issued directly by the system, or may be issued through a “brand” (i.e., a “branded” card), much in the way conventional credit cards may be issued directly by a financial institution or indirectly through another entity, such as a club or a business. Also associated with the system are one or more partners (who may be vendors or intermediaries to vendors), who have agreed to accept payment using the smart cards, but who may also accept payment by other means, such as conventional credit cards or conventional or electronic currency. From time to time, or on an ongoing basis, the partners may wish to provide special incentives to users who shop and purchase from them. Furthermore, the system operator may find it beneficial to maximize the number of users who make purchases with the smart card, rather than other financial instruments. To this end, the present invention allows the participating partners to offer incentives to smart card users.

In order for the user to take advantage of the incentives offered by the participating partners, the user's system 100 or smart card 170 must be able to recognize which of the partners are offering incentives and what those incentives are. Embodiments of the present invention provide a system by which this recognition and the distribution of incentives can occur. Preferably, these incentives only appear to people that are using a smart card while shopping at the partner's venue. A smart card user may use the incentives to modify the normal terms of a purchase of any sellable resource (goods, services, or any other sellable thing); that is, the incentive adds, deletes, qualifies or otherwise modifies one or more terms of the sale relative to the terms that are normally provided to non-smart card customers. Although this modification may be directly between the smart card user and the partner (such as a rebate or other special offer by the partner), the modification also may be between the smart card user and a third party (such as offering incentive points to accumulate towards some other potential transaction—e.g. earning airline “miles” based on the amount of the purchase).

Reference will now be made in detail to various preferred embodiments of the invention, examples of which are illustrated in the accompanying drawings in which like reference numerals refer to corresponding elements.

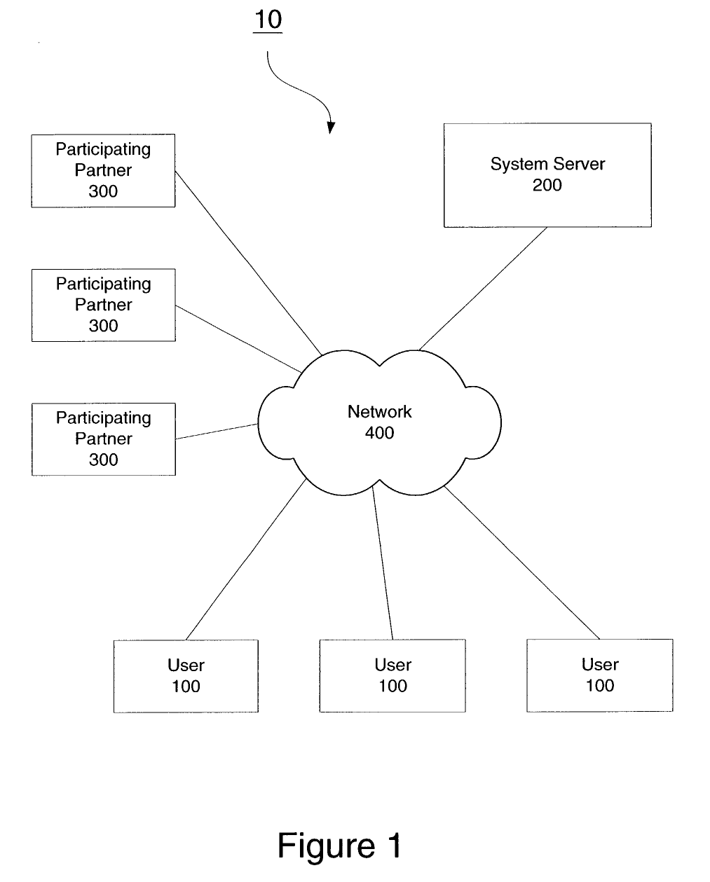

FIG. 1 illustrates an environment for implementing an electronic purchasing system 10. In the displayed embodiment, the electronic purchasing system 10 operates between at least one user system 100a . . . n, a system server 200, and at least one participating partner system 300a . . . n. The user system 100, system server 200, and participating partner 300 may communicate over a network 400.

The network 400 preferably comprises the Internet, which functions as a means for connecting the system server 200, user system 100, and participating partner 300. The network 400 could alternatively comprise a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. The user system 100, system server 200, and participating partners 300 may further communicate via any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. Additionally, the system server 200 may interface with the user system 100 and participating partners 300 through any one or more of an RS-232 serial connection, an IEEE-1394 (Firewire) connection, a Fibre Channel connection, an IRDA (infrared) port, a SCSI (Small Computer Systems Interface) connection, a USB (Universal Serial Bus) connection or other wired or wireless, digital or analog interface or connection.

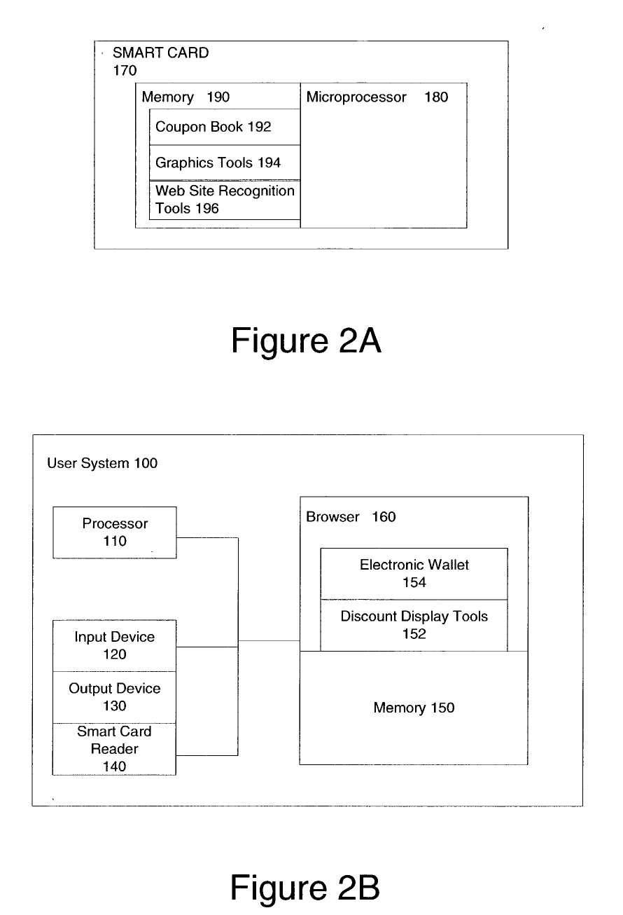

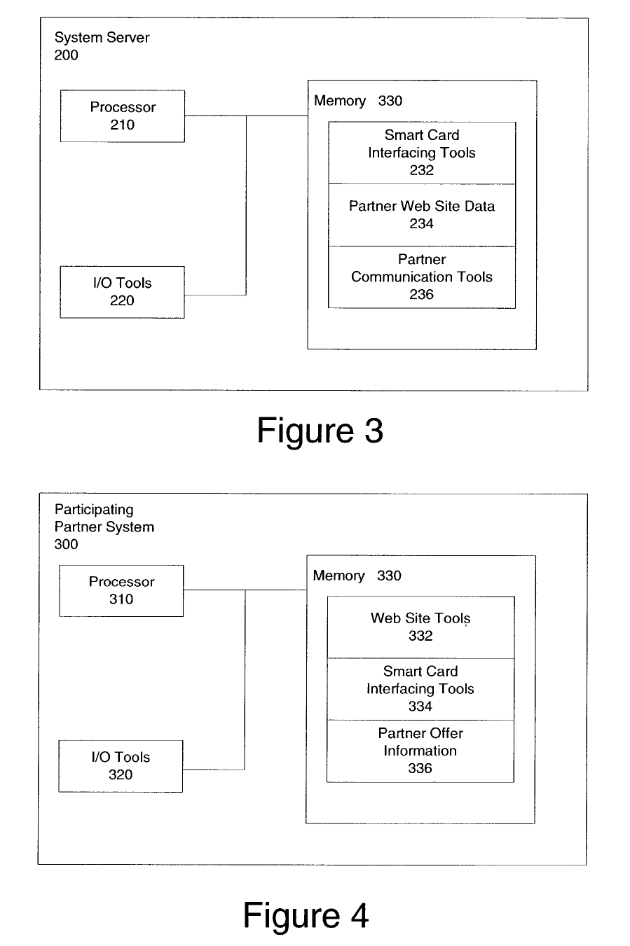

Each of the users 100 may access the system server 200 via a computer having an Internet connection. Specific embodiments of the user systems 100 and the system server 200 are described in detail with reference to FIGS. 2 and 3 respectively.

FIGS. 2A and 2B represent embodiments of a user system 100 and an associated smart card 170. The user system 100 preferably comprises a smart card reader 140 for reading information stored on the smart card 170.

FIG. 2A illustrates an embodiment of a smart card 170 that operates in conjunction with the user system 100 described above. In one embodiment, the smart card 170 includes a microprocessor 180 and a memory 190. The memory 190 preferably stores an electronic coupon book 192, graphics tools 194, and web site recognition tools 196. In another embodiment, the memory 190 may include electronic coupon book access tools that access an electronic coupon book 192 that is stored remotely from the smart card 170.

The electronic coupon book 192 contains data records of special offers or other incentives that a user 100 is able to use when shopping over the network 400. The data records of these incentives are referred to generally herein as coupons or discounts, but these terms are not intended to limit the scope of incentives that may be offered by the present invention. The coupons may comprise any sales incentive, such as an offer to reduce prices for all purchases made through the participating partner offering the coupon (i.e., a global vendor discount), an offer to reduce the price for the purchase of a particular good or particular classes of goods, and so on. The coupons may be associated with particular participating partners or groups of partners, and the partners or the system may be responsible for honoring the coupon. For example, in an embodiment in which the coupon is an offer in which any purchase made on the participating partner's system by the user will be discounted by a particular percentage, then either the participating partner or the system may be responsible for ultimately absorbing the cost of the discount. The manner in which the electronic coupon book 190 is populated with coupons and the features of the coupons are described in more detail elsewhere herein.

The web site recognition tools 196 are capable of recognizing a partner system 300. When the web site recognition tools 196 recognize a partner system 300, such as by recognizing the URL address or other indicia of a website hosted by the partner system 300, other tools may search for and download coupons applicable to the partner system 300 to the smart card 170. Alternatively, or in addition, the other tools may access a known coupon that is associated with the partner system 300 and stored in an electronic coupon book 192 located on the smart card 170 or elsewhere (such as in the memory of user system or server system). When it is determined that a coupon exists for a the partner system 300 being visited by the user, discount display tools (described herein in conjunction with the user system 100) may cause an offer to appear on the user system 100.

The graphics tools 194 cause a pre-determined graphical interface to appear on a display of the user system 100. The graphics tools 194 may provide different “skins” (i.e., graphical and/or functional schemes or patterns) based on the source of the smart card, user preference, or other criteria. For example, the skin may be tailored to graphically suggest the visual indicia of the smart card issuer by using certain colors or logos. The graphics tools also may spawn graphics programs (such as Flash Media) that display animations and the like.

As shown in FIG. 2B, user system 100 may further be or include, for instance, a personal computer running the Microsoft Windows™ 95, 98, Millenium™, NT™, or 2000, WindoWS™CE ™, PaImOS™, Unix, Linux, Solaris™, OS/2 ™, BeOS ™, MacOS™ or other operating system or platform. User system 100 may include a processor 110 such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control. User system 100 may furthermore include electronic memory 150 such as RAM (random access memory) or EPROM (electronically programmable read only memory), storage such as a hard drive, CDROM or rewritable CDROM or other magnetic, optical or other media, and other associated components connected over an electronic bus, as will be appreciated by persons skilled in the art. User systems 100 also may be or include a network-enabled appliance such as a WebTV™ unit, radio-enabled PalM™ Pilot or similar unit, a cable box, a set-top box, a networkable game-playing console such as Sony Playstation™ or Sega Dreamcast™, a browser-equipped cellular telephone, or other TCP/IP client or other device.

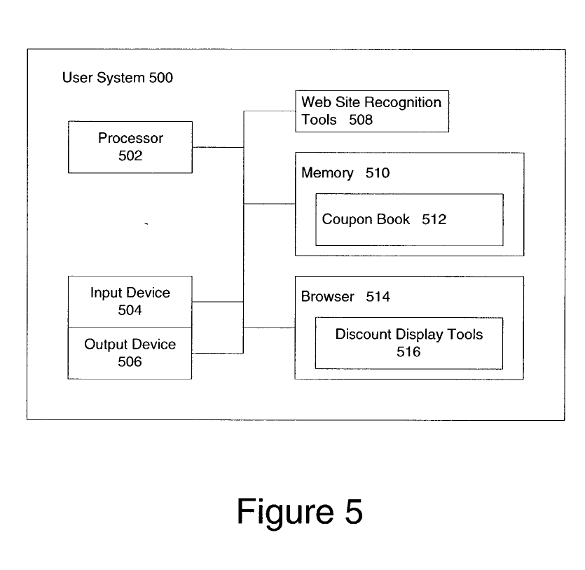

Also as shown in FIG. 2B, an embodiment of the user system 100 includes a browser 160, discount display tools 152, an input device 120, an output device 130, and a smart card reader 140. An electronic wallet 154 may be stored in the memory 150. The aforementioned components may be comprised of any standard computer components as described above capable of performing the method described below with reference to FIGS. 5-9.

The discount display tools 152 are capable of displaying user discounts available from coupons in the electronic coupon book 192. The displayed discounts may include both available discounts and discounts received in conjunction with previous offers. In one embodiment, the display may include a ledger or account-type listing of all or some of the discounts that the user has received. Such a functionality may provide the user with reinforcing feedback that the user is benefiting from using the smart card and the participating partners. The discount display tools may present a single coupon in a separate “window,” which may be tailored to replicate the appearance of a conventional paper coupon.

In another embodiment, the discount display tools 152 may offer a passive indicator that the user will receive a benefit by making a purchase using the smart card on the partner system 300 that the user is currently visiting. A passive indicator is one that does not explicitly state the special offer terms. For example, when it is determined that the user is visiting a participating partner system 300 that offers an incentive for using the smart card, a logo or icon may be activated to appear to the user. The logo or icon may be a small, unobtrusive display that appears as part of the present display, or as a new display (e.g., as a new “window”). For example, the logo “Your smart card is welcome here” may appear on the screen, or a small static or animated icon of a smart card may appear in the corner of the screen. In a preferred embodiment, a small and unobtrusive animated icon that depicts a slowly rotating smart card is opening in a separate window for the user to see. When the user sees the icon, it will be understood that the use of the smart card will provide some benefit. In one embodiment, the icon may be activated to determine what the offered incentive is by using a graphical pointer to “click” on the icon, “hovering” over the icon, or by any other known means. In another embodiment, the terms of the incentive may be determined by reference to information contained on the partner web site.

Although the passive indicator may not explicitly state the terms of the offer, it may be used to provide some implicit disclosure of the offer terms. For example, in an embodiment in which the passive indicator comprises a small icon of a smart card (which preferably is animated to show the card rotating or otherwise moving or polymorphing), the color of the icon may be selected to designate the magnitude of the offer terms. For example, a silver icon may indicate 5% discounts, while a gold icon may indicate 10% discounts. A key to the meaning of the particular icons may be provided, for example, at the system home page, or no key may be provided.

The electronic wallet 154 preferably stores information such as credit card numbers, shipping addresses, billing addresses, preferred delivery modes, and any other information that may be useful for form filling on vendor web sites. While in the displayed embodiment, the electronic wallet 154 is stored on the user system, it is also possible to store the electronic wallet 154 on the smart card 170 if sufficient memory 190 is available, or on another storage medium, such as in the memory of the system server 100, accessible through the network 400. The electronic wallet 154 also may contain the electronic coupon book 192 or a supplemental or back-up electronic coupon book 192.

The input device 120 may include any known user input devices such as a keyboard, a mouse, a touch screen, etc. Likewise, the output device 130 could include any known user output devices such as any type of display or printer.

The user system 100 may optionally include a portable phone or similar device. A smart card reader could be provided integrally with the phone, such that a slot in the phone receives the smart card 170.

The electronic coupon book 192 stored on the smart card 170 may be loaded and activated through several different mechanisms. With regard to loading, either the system server 200 or the participating partner 300 may send coupons to the user system 100 for loading on the smart card 170. The coupons may be sent proactively, such as by using any known file transferring protocol, an email transfer, or by mailing or otherwise providing software to the user. For example, an email may be sent to the user containing an executable file that updates the electronic coupon book 192 with the most recent list of participating partners and their coupons. The sending of coupons may be implemented in a subscription service in which the user may or may not be charged to receive the coupons.

The coupons also may be sent reactively upon a request or other action taken by the user. For example, a participating partner system 300 may send a coupon to the user system 100 for loading when the user system 100 visits the partner system 300. The user may then download and use the coupon, which may be valid for one or more purchases. Of course, it is understood that if the user desires to immediately use a coupon that is sent by a participating partner, it may be unnecessary to store the coupon in permanent memory in the electronic coupon book 192. The user system 100 also may contain tools for periodically collecting coupons from a database on the server system 200, or by searching for coupons from partner systems 300. For example, the user system 100 may periodically obtain an updated list of partners and coupons from the server system, or may obtain an updated list of participating partners then query each of these partners for recent coupons.

In any of the foregoing embodiments (i.e., whether the loading of coupons is done proactively, reactively, or both) the user may be given the opportunity to accept or reject any or all of the coupons. Furthermore, a user's preferences for coupons may be stored in the smart card memory 190, the electronic wallet 154, the server system memory 330 or elsewhere. The user's preferences may indicate that certain coupons (such as those from certain partners or types of partners) are to be accepted and others are to be rejected. The smart card 170 or electronic wallet 154 also may contain management tools for allowing the user to organize, add and remove coupons.

In another embodiment, the coupons may be “transparent” to the user; that is, the user may not know about the coupons or the manner in which they are transmitted and stored. In the “transparent” coupon embodiment, the applicable coupons are simply displayed to the user upon visiting a partner system 300 without requiring any interaction by the user to obtain the coupons.

In the illustrated embodiment, the smart card 170 includes web site recognition tools 196 for recognizing the partner system 300 in order to trigger loading. However, in an alternative embodiment, the partner system 300 may trigger the loading by recognizing a cookie or other indicia on the user system 100. In yet a further alternative embodiment, the system server 200 may collect coupon offers from the partner systems 300 and load the coupons onto the smart card 170, either on the initiative of the system server 200 or upon the request of the user system 100.

Once coupons have been loaded into the electronic coupon book 192, the coupons may be utilized upon a visit to an appropriate partner system 300. The partner system 300 may include a web site (or other “virtual” establishment) or a payment system within a partner's “brick-and-mortar” establishment, such as a smart card reader in a partner retail establishment, restaurant or other type of partner establishment in which goods and services can be purchased.

If the partner system 300 includes a web site, the web site recognition tools 196 on the smart card 170 may activate the graphics tools 194 in order to activate a display of a coupon from the electronic coupon book 192, or simply a passive indicator that incentives are available, on the user system output device 130. If the partner system 300 is a brick-and-mortar establishment, the partner system may invoke a routine to display the coupon on the register screen upon recognizing that a coupon is available to the customer has a smart card.

In one embodiment, the partner's web site may not actually accept payments, but instead loads coupons to the a smart card for use at brick-and-mortar establishments. In such an embodiment, the coupon may be displayed both on the web site and on the brick-and-mortar establishment's purchasing system.

An embodiment of the system server 200 is shown in FIG. 3. The system server 200 may be or include, for instance, a workstation running the Microsoft Windows™ NT™, Windows™ 2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. The system server 200 preferably includes a processor 210, I/O tools 220, and a memory 230. The processor 210 serves to regulate data flow between all of the aforementioned components. The I/O tools 220 may link the system server 200 with the network 400 and further may comprise any standard components that allow a service provider to access the system server 200. The processor 210 accesses a plurality of tools stored in the memory 230 including smart card interfacing tools 232, partner web site data 234, and partner communication tools 236.

The smart card interfacing tools 232 may include a mechanism for reading from and writing to the smart card 170 and/or the user system 100. In one embodiment, the smart card interfacing tools 232 download information received from the partner systems 300 to the smart card 170.

The partner web site data 234 may include rules and instructions provided by partners as to the conditions and circumstances under which incentives should be provided. The rules may include the features of the incentive being offered and the terms and duration of the coupons that are supplied to the smart cards 170 and/or user systems 100. Additional partner information may be provided as agreed between the sponsor and the partner system 300.

The partner communication tools 236 may include any appropriate mechanism for communicating with a partner over the network 400 or directly. The partner communication tools may allow a partner register to become a participating partner on the electronic purchasing system 10 by filling in pre-defined forms, and may allow the partner to designate a number of additional web sites or locations for participation. Of course, registration also may be accomplished by phone, mail, email, or other techniques. The partner communication tools 236 further may allow partner systems 300 to provide any additional required information.

An embodiment of a participating partner system 300 is shown in greater detail in FIG. 4. The partner system 300 preferably comprises a processor 310, I/O tools 320, and memory 330. The memory 330 preferably includes web site tools 332 for presentation of a partner web site, smart card interfacing tools 334 for sending information to and receiving information from the smart card 170, and partner offer information 336. The partner offer information 336 includes information related to discounts, promotions and other incentives applicable to smart card users, and may be stored as partner web site data 234 (and ultimately as coupons) in embodiments in which the partner system 300 provides this data to the system server 200. Furthermore, as suggested before, in some embodiments the partner offer information 336 may be directly loaded onto a user's smart card 170 or user system 100 as coupons. Of course, other information may be stored as partner offer information 336 that is shared only with smart cards 170, with the system server 200, with other partner systems 300, or with nobody.

In one embodiment, a partner system 300 may wish to share partner offer information 336 with other partner systems 300 to collaborate on offering incentives. In such an embodiment, two partner systems 300 may wish to provide incentives to users to purchase goods on both their systems by notifying the user of similar or related goods that are being sold by another partner. For example, a fishing supply store partner may offer a discount on fishing supplies, and may connect this offer to discounted fishing vacations that are offered by a travel agency partner. A user making a purchase from either partner may be offered the other incentive as a “package deal.”

It is understood that the software, hardware and other components of the user system 100, system server 200 and participating partner system 300 described herein may be integrated or distributed over one or more terminals, processors, networks or devices that are interconnected to provide the desired features and functionality. For example, the web site tools 332 and smart card interfacing tools 334 of the partner system 300 may be integrated into a single software program or may be separate routines running separately on remote computers. Furthermore, some or all of the distributed software, hardware and other components may be owned or operated by entities other than the user, system and partners.

The invention described thus far has been described in the context of an arrangement in which the system issues a smart card to the system user, however, the present invention also may be used in the context of an arrangement in which the system issues a conventional credit card or other credit instrument to the system user. In such an arrangement, the credit card issuer may wish to partner with goods and service providers to offer incentives only to the credit card holders that have credit cards issued by the credit card issuer. FIG. 5 illustrates an embodiment of a user system 500 that may be used in this alternative context.

In the embodiment of FIG. 5, the user system 500 comprises: a processor 502, an input device 504, an output device 506, web site recognition tools 508, a memory 510, a browser 514 and discount display tools 508. The memory 510 of the user system 500 also may include a coupon book 512 for storing electronic coupons. Each of these components may have features, uses and functions similar to analogous components described in detail elsewhere herein. The use of the user system 500 is likewise similar to the use of user system 200. For example, the user system 500 uses the web site recognition tools 508 to identify partner systems 300 (or vice-versa) and the processor 502 then initiates the transfer of an electronic coupon, incentive or other offer provided by the partner system 300. If the coupon is used immediately, there may be no need to store the coupon on the user system, and the coupon book 512 may not be necessary, however it is anticipated that in some cases it may be desirable to store some record of the coupon or the coupon's use in the user system memory 510, even if the coupon is used immediately.

The operation of user system 500 of FIG. 5 differs from user system 200 with respect to the transactional steps used to consummate a purchase or coupon redemption. For example, when a system user decides to make a purchase using one an electronic coupon, the user may be required to manually enter information that would normally be supplied directly from the electronic wallet. In this embodiment of the invention, the system user may use the credit card to consummate the transaction in any known manner, as will be understood by those of ordinary skill in the art in light of the present teachings.

The management and presentation of coupons in the embodiment of FIG. 5 also is similar to that of the other embodiments described herein, and any of the aforementioned embodiments may be used with user system 500. For example, in a preferred embodiment of user system 500, the discount display tools 516 may be invoked to offer a passive indicator that the user will receive a benefit by making a purchase using the credit card issued by the system on the partner system 300 that the user is currently visiting. For example, a small, unobtrusive logo or icon may be activated to appear to the user, as described elsewhere herein. When the user sees the icon, it will be understood that by using the system-issued credit card the user will receive some sort of discount or other benefit.

The user system 500 described with reference to FIG. 5 is tailored to providing the benefits of the present invention to issuers and users of conventional credit cards, but is will be understood that user system 500 also may be adapted for use in the smart card context, as described previously herein. The two systems also may be combined to allow the use of either smart cards or conventional credit cards.

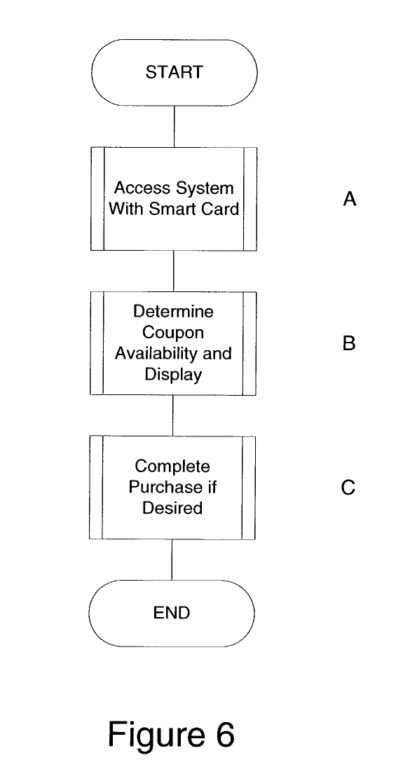

FIG. 6 illustrates three procedures involved in an embodiment of a method of the invention. In procedure A, a cardholder accesses the electronic purchasing system 10 with a smart card 170. In procedure B, a determination is made whether there are any coupons or other incentives associated with the partner system 300 that are stored on the smart card 170 (or available to the smart card 170 from the partner system 300 or the system server 200). Finally in procedure C, the card holder completes a purchase with the use of the smart card 170, receiving the benefit of an associated coupon or incentive if one is available. Each of procedures A, B, and C is described in greater detail below.

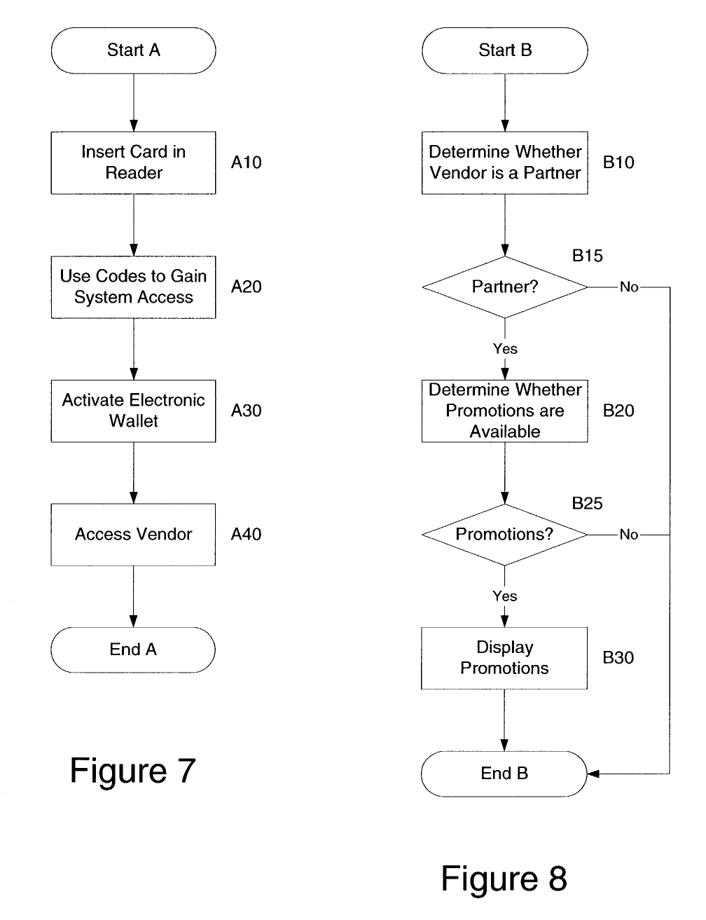

FIG. 7 illustrates the steps of a preferred embodiment of a procedure A in which a cardholder accesses the system 10 using the smart card 170. In step A10, the cardholder inserts the smart card 170 into the card reader 140 of the user system 100. Alternatively, the cardholder may insert the smart card 170 directly into a smart card reader 140 connected with the system server 200 or a partner system 300, as may occur when making a brick-and-mortar transaction. In step A20, the cardholder may input codes (such as a name and password) to gain access to the applicable system. In step A30, the electronic wallet 154 is activated. The electronic wallet 154 may be stored on the smart card 170 or elsewhere on the user system 100. In step A40, the cardholder accesses a partner system 300 or a vendor system by way of a partner system 300. As noted before, a partner system 300 may be a vendor and/or a gateway system through which vendors present and/or sell goods, services and the like.

FIG. 8 is a flow chart illustrating the steps involved in a preferred embodiment of procedure B. In step B a determination is made whether the vendor being visited by the user is a partner (i.e., one that is registered to provide incentives to smart card users). In step B10, a trigger is activated by web site recognition tools 196 if the vendor is a partner. The website recognition tools 196 may operate passively, such as by reading a URL or other indicia that identifies partner sites and comparing the URL to a list of known partners (which may be locally stored on the user system 100 or remotely stored on the system server 200). The website recognition tools also may operate actively, such as by sending a query (using XML or any other communication or file sharing protocol) to the site and receiving a confirmation response from the partner site. As an alternative, a partner system 300 may automatically recognize cookies or other indicial on the user system, or may query the user system as described above. Preferably a method is used that reduces bandwidth requirements, yet maintains a high degree of security. As such, URL recognition by the user system 100 and/or cookie recognition by the partner system 300 are preferred embodiments. If recognition occurs in step B15, partner system 300 may search locally for any applicable partner offer information or promotions 336 in step B20, or may query the system server 200 for promotions, or may query the smart card (via the user system 100) for stored coupons or incentives. If a coupon is located on the smart card 170 or system server 200, but is not matched to an existing incentive currently being offered by the partner system 300 (an unverified coupon), the partner system may delete or send an instruction to delete the coupon from the smart card 170 and/or system server 200. Also upon finding an unverified coupon the partner system 300 may initiate a command to notify the user system 100 and/or system server 200 that the coupon is invalid or expired, or may simply suppress any display of a coupon at all.

If the partner system 300 finds any applicable promotions in step B25, the graphics tools 194 cause the promotions to be displayed on the user system 100, as described elsewhere herein, in step B30. For example, the partner system 300 may instruct the user system to display a coupon, offers having any other format, or an icon indicating that incentives are, available but without describing them. The display may also include a list of links where other applicable promotions can be found.

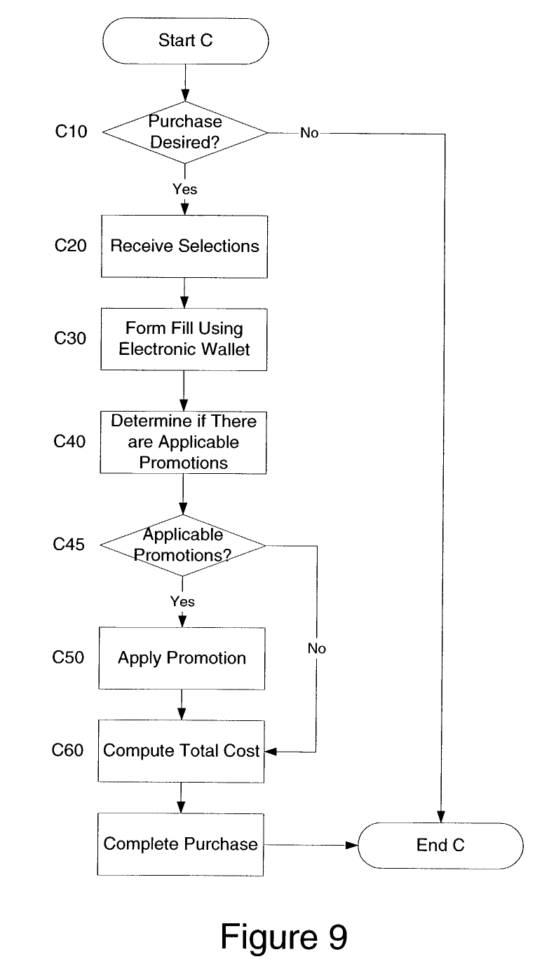

FIG. 9 is a flow chart illustrating the steps involved in a preferred embodiment of procedure C. If a cardholder desires a purchase in step C10, the partner system 300 receives the selection in step C20. In step C30, the electronic wallet 154 automatically form fills some or all of the purchase information on the partner system 300. In step C40 the partner system 300 or the smart card 120 determines whether the any coupons that are applicable to the partner system 300 are also applicable to the particular purchase that the user desires to make. If applicable promotions exist in step C45, the electronic wallet 154 applies the promotion in step C50 and the partner system 300 computes total cost in step C60. The purchase is completed in step C70 by using known payment processing techniques. In an additional step (not shown), the coupon also may be purged or deleted from the electronic coupon book 192 if it is determined that the coupon is valid only for a single transaction or is otherwise expended by the transaction. Such a deletion may be performed by a command from the smart card 170, the user system 100, the system server 200 and/or the participating partner system 300.

In one embodiment of step C50, the partner system 300 applies the promotion by comparing the terms of the promotion to the normal terms of sale for the good or other item being sold, and modifying (or replacing) the normal sale terms. The normal terms of sale may be stored in a database of sales information in the participating partner system memory 330. In one embodiment, for example, the sale price of an item may be reduced. In another exemplary embodiment, in which an item is only offered to smart card users that have the applicable coupon, the terms of sale may be modified by replacing a term of “unavailable for purchase” with a term of “available for purchase at X price.” In another embodiment of step C50, the partner system 300 identifies the coupon by reference to a coupon indicia (such as a serial number or an identification number or code) and applies the promotion by selecting appropriate sales information from a database of sales information relating to the coupon indicia. For example, the coupon indicia may be used to select a particular set of sales information for an item, without having to refer to normal sales terms for the item. In either embodiment, the step C50 may be thought of as modifying the sales terms or information because in both cases the sales terms for smart card customers are somehow different from those offered to non-smart card customers.

Similar processes may be used in an embodiment in which the system user is making a purchase using a conventional credit card or other payment means through a device such as user system 500 described with reference to FIG. 500. In these embodiments, the smart card would be replaced by a conventional credit card, and the user may be required to manually enter information that would normally be received from an electronic wallet.

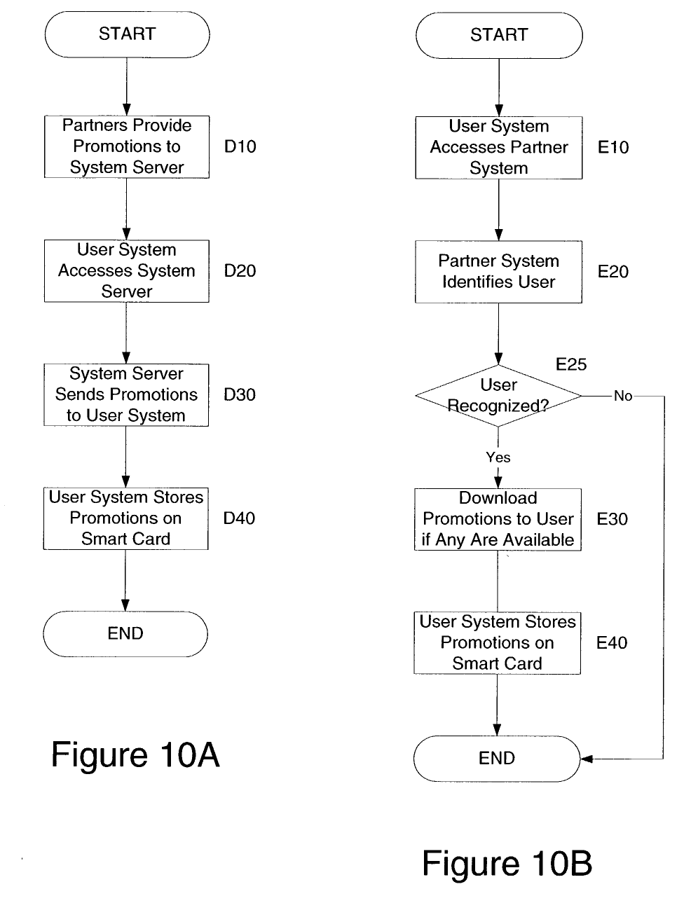

Referring now to FIGS. 9A and 9B, two embodiments of methods for loading coupons into the smart card electronic coupon book 192 are described. FIG. 10A illustrates an embodiment of a method in which the system server 200 loads coupons onto the user system 100. The loading may be offered at regular intervals through a subscription service or by other suitable means. In step D10, partner systems 300 provide promotional information to the system server 200, indicating the coupons or other incentives that will be made available to users that make purchases with their smart cards. Preferably this information includes the details, including the duration, of the incentive. The information also may include an offering schedule that informs the system server 100 when to return to download additional incentives, which may be useful to avoid unnecessary querying of the partner system 300 by the system server 200. In step D20, the user system 100 accesses the system server 200. In step D30, the system server 200 sends the promotional information to the user system 100. In step D40, the user system 100 stores the promotional information on the smart card 170. In an another embodiment, in step D30 the server system may send the user system 100 a location where the promotional information can be picked up by the smart card 170, and in step D40 the system server stores the promotional information at that location. In still another embodiment, the user may not be required to access the system server, and instead the system server 200 can send the promotions to the user system 100, as described elsewhere herein.

FIG. 10B illustrates an embodiment of a technique through which the partner system 300 may download promotional information to the user systems 100. In step E10, the user system 100 accesses the partner system 300. Such access may occur over a network 300 or directly through a smart card reader 140 associated with the partner system 300. In step E20, recognition occurs. As set forth above, either the smart card 170 recognizes the partner system 300 or the partner system 300 detects cookies on the user system 100. If recognition occurs in step E25, the partner system 300 downloads the promotional information to the user system 100 in step E30. In step E40, the user system 100 stores the promotional information on the smart card 170. In an alternative embodiment, the partner system may instead send the promotional information directly to the user system as a subscription service between the smart card user and the partner.

It will be apparent to those skilled in the art that various modifications and variations can be made to the system and method of the present invention without departing from the scope or spirit of the invention. For example, in many cases the above steps and procedures may be rearranged and modified without departing from the scope of the invention. Thus, it is intended that the present invention cover modifications and variations of this invention provided they come within the scope of the appended claims and their equivalents.

What is claimed is:

1. An electronic purchasing system for enabling a user to purchase goods and services from at least one vendor, the purchasing system comprising:
a smart card for communicating with the at least one vendor, the smart card comprising:
an electronic coupon book for storing at least one electronic coupon,
coupon downloading tools for transferring the at least one electronic coupon to the electronic coupon book, and
vendor recognition tools for identifying a specific vendor and accessing an applicable electronic coupon associated with the specific vendor;
an electronic wallet comprising:
account access information for at least one user account, and
purchasing tools;
wherein the purchasing tools are adapted to allow a user to complete a purchase transaction using the account access information, and at least some of the terms of the purchase transaction are based on the applicable electronic coupon associated with the specific vendor.

2. The electronic purchasing system of claim 1, wherein the electronic wallet is stored on the smart card.

3. The electronic purchasing system of claim 1, further comprising a user system, the user system comprising:
network interface tools for communicating over a network with the at least one vendor; and
a smart card reader for communicating with the smart card.

4. The user system of claim 3, the user system further comprising:
a browser for accessing one or more venues associated with the at least one vendor; and
a memory for storing the electronic wallet.

5. The electronic purchasing system of claim 1, further comprising graphics tools for displaying the at least one electronic coupon on a user system.

6. The electronic purchasing system of claim 1, wherein the graphics tools are stored on the smart card.

7. The electronic purchasing system of claim 1, wherein the electronic wallet further comprises tools for filling out participating vendor forms in order to make a purchase.

8. The electronic purchasing system of claim 7, wherein the electronic wallet includes user shipping preference and address information.

9. The electronic purchasing system of claim 7, wherein the electronic wallet includes credit card numbers.

10. The electronic purchasing system of claim 1, further comprising means for receiving electronic coupons from a system server.

11. The electronic purchasing system of claim 1, further comprising means for receiving applicable coupons from a partner system.

12. The electronic purchasing system of claim 1, wherein the smart card stores a list of participating vendors.

13. The electronic purchasing system of claim 1, wherein the electronic wallet stores a list of participating vendors.

14. The electronic purchasing system of claim 1, wherein at least one of the at least one electronic coupon includes an expiration date.

15. An electronic purchasing system for enabling a user to purchase goods and services from at least one vendor, the purchasing system comprising:
an electronic wallet comprising:
an electronic coupon book for storing at least one electronic coupon,
coupon downloading tools for transferring the at least one electronic coupon to the electronic coupon book,
vendor recognition tools for identifying a specific vendor and identifying at least one applicable electronic coupon associated with the specific vendor,
account access information for at least one user account, and purchasing tools;
a smart card for consummating a purchase transaction with the at least one vendor, the smart card comprising:
coupon access tools for accessing the at least one applicable electronic coupon; and
wherein the purchasing tools are adapted to allow a user to complete a purchase transaction using the account access information, and at least some of the terms of the purchase transaction are based on the applicable electronic coupon associated with the specific vendor.

16. The electronic purchasing system of claim 15, wherein the electronic wallet is stored on the smart card.

17. A user system for enabling a user to purchase goods and services from at least one vendor, the user system comprising:
an electronic wallet;
an electronic coupon book for storing at least one electronic coupon;
coupon downloading tools for transferring the at least one electronic coupon to the electronic coupon book, each of the at least one electronic coupons comprising promotion terms;
vendor recognition tools for identifying a specific vendor and identifying at least one applicable electronic coupon associated with the specific vendor;
coupon access tools for accessing the at least one applicable electronic coupon, account access information for at least one user account;
purchasing tools;
a smart card for consummating a purchase transaction with the at least one vendor;
communication tools for communicating with at least one vendor system; and
wherein the purchasing tools are adapted to allow a user to complete a purchase transaction using the account access information, at least some of the terms of the purchase transaction being modified by reference to the promotion terms of the applicable electronic coupon associated with the specific vendor.

18. The user system of claim 17, wherein at least one of the electronic wallet, electronic coupon book, coupon downloading tools, vendor recognition tools, coupon access tools, account access tools, and purchasing tools is stored on the smart card.

19. The user system of claim 17, wherein at least one of the electronic coupon book, coupon downloading tools, vendor recognition tools, coupon access tools, account access tools, and purchasing tools is stored on the electronic wallet.

20. The user system of claim 17, wherein the communication tools comprise:
network interface tools for communicating over a network with the at least one vendor; and
a smart card reader for communicating with the smart card.

21. The user system of claim 17, the user system further comprising:
a browser for accessing one or more venues associated with the at least one vendor; and
a memory for storing the electronic wallet.

22. The user system of claim 17, further comprising graphics tools for displaying the at least one electronic coupon on the user system.

23. The user system of claim 17, wherein the electronic wallet further comprises tools for filling out participating vendor forms in order to make a purchase.

24. The user system of claim 23, wherein the electronic wallet includes user shipping preference and address information.

25. The user system of claim 23, wherein the electronic wallet includes credit card numbers.

26. The user system of claim 17, further comprising means for receiving electronic coupons from a system server.

27. The user system of claim 17, further comprising means for receiving applicable coupons from a partner system.

28. The user system of claim 17, wherein the smart card stores a list of participating vendors.

29. The user system of claim 17, wherein the electronic wallet stores a list of participating vendors.

30. The user system of claim 17, wherein at least one of the at least one electronic coupon includes an expiration date.

31. A user system for enabling a user to purchase goods and services from at least one vendor, the user system comprising:
coupon downloading tools for transferring at least one electronic coupon, each of the at least one electronic coupons comprising promotion terms;
vendor recognition tools for identifying a specific vendor and identifying at least one applicable electronic coupon associated with the specific vendor;
purchasing tools;
an input device for receiving account access information from a user;
communication tools for communicating with at least one vendor system; and
wherein the purchasing tools are adapted to allow a user to complete a purchase transaction using the account access information, at least some of the terms of the purchase transaction being modified by reference to the promotion terms of the applicable electronic coupon associated with the specific vendor.

32. The user system of claim 31, further comprising:
a system-issued credit instrument for consummating a purchase transaction with the at least one vendor;
an electronic coupon book for storing at least one electronic coupon; and
coupon access tools for accessing the at least one applicable electronic coupon.

33. A method for allowing a user to utilize automated coupons from at least one participating vendor over a network, the method comprising:
providing a user with an electronic wallet and a smart card;
providing a user with at least one automated coupon;
determining whether a user is accessing a participating vendor;
implementing notification tools to provide the user with notification of an applicable automated coupon in response to the user accessing a participating vendor; and
enabling the user to purchase goods or services using the electronic wallet and the at least one automated coupon, at least some of the terms of the purchase being modified by the automated coupon.

34. The method of claim 33, wherein the notification tools are stored on at least one of the smart card and the electronic wallet.

35. The method of claim 33, further comprising:
storing credit card information and personal information in the electronic wallet; and
wherein the step of enabling the user to purchase goods or services using the electronic wallet further using at least some of the credit card information and personal information.

36. The method of claim 33, wherein the step of determining whether a user is accessing a participating vendor comprises recognizing a partner system using recognition tools stored on the smart card.

37. The method of claim 33, wherein the step of determining whether a user is accessing a participating vendor comprises recognizing cookies on a user system.

38. The method of claim 33, wherein the step of providing a user with at least one automated coupon comprises transmitting coupons from the participating vendor to the smart card.

39. The method of claim 31, further comprising:
a system server attached to the network; and
wherein the step of providing a user with at least one automated coupon comprises transmitting coupons from the system server to the smart card.

41. The method of claim 40, further comprising the step of transmitting coupons from a participating partner system to a system server.

42. The method of claim 40, wherein the step of implementing notification tools comprises invoking a display comprising a graphical depiction of a coupon.

43. The method of claim 42, wherein the graphical depiction of a coupon comprises a description of terms of an automated coupon associated with the participating vendor.

44. The method of claim 40, wherein the step of implementing notification tools comprises invoking a display comprising a passive indicator.

45. A method for allowing a user to utilize automated coupons from at least one participating vendor over a network, the method comprising:
providing a user with at least one automated coupon;
determining whether a user is accessing a participating vendor;
implementing notification tools to provide the user with notification of an applicable automated coupon in response to the user accessing a participating vendor;
receiving payment information from a user; and
enabling the user to purchase goods or services using the payment information and the at least one automated coupon, at least some of the terms of the purchase being modified by the automated coupon.
